(19) United States
(12) Patent Application Publication
(10) Pub. No.: US 2026/0046805 A1
(43) Pub. Date: Feb. 12, 2026

(54) Methods for Data Collection for AI-based Positioning Model Training in Wireless Network

(71) Applicant: InterDigital Patent Holdings, Inc., Wilmington, DE (US)

(72) Inventors: Guanzhou Wang, Brossard (CA); Ulises Olvera-Hernandez, Saint-Lazare (CA); Jung Je Son, Warrington, PA (US); Achref Methenni, Montreal (CA); Zhibi Wang, Woodridge, IL (US)

(73) Assignee: InterDigital Patent Holdings, Inc., Wilmington, DE (US)

(21) Appl. No.: 18/798,270

(22) Filed: Aug. 8, 2024

(51) Int. Cl. H04W 64/00; H04W 24/08; H04W 24/10

(52) U.S. Cl. CPC H04W 64/00; H04W 24/08; H04W 24/10

(57) ABSTRACT

A network device may receive a request for positioning training data that includes an indication of environmental characteristics associated with the positioning training data, and determine a target area to collect the positioning training data based on the request. The target area may be based on the environmental characteristics associated with the positioning training data or availability of one or more PRUs or RAN nodes that are capable of providing the positioning training data. The network device may determine a list of PRUs that can provide the positioning training data, determine a positioning measurement type associated with the positioning training data, and send a collection request for the positioning training data, where the collection request may include an indication of the target area, the list of the PRUs, and the positioning measurement type. The network device may receive a positioning training data report that includes the positioning training data.

### BACKGROUND

LTE/NR positioning methods may be geometry based and may not perform well in some conditions, such as when line of sight (LOS) measurements are not available. Artificial Intelligence (AI) and/or Machine Learning (ML) based algorithms may improve the positioning accuracy in those conditions. Direct AI/ML positioning and/or AI/ML-assisted positioning may be provided. With Direct AI/ML positioning, the AI/ML model may produce user equipment (UE) location as the output, while with AI/ML-assisted positioning, the AI/ML may produce enhanced measurements for UE positioning calculations.

### SUMMARY

A Model Training logical function (MTLF) may be a logical function that is configured to train Machine Learning (ML) models and expose new training services. The MTLF may derive positioning model training data collection strategy based on received model training request. The MTLF may locate a Location Management Function (LMF) and request that the LMF execute data collection strategy. The LMF may determine training data collection based on the model training request and execute the data collection according to the strategy.

A network device may include one or more processors that are configured to receive a request for a positioning artificial intelligence or machine learning (AI/ML) model. The request may include an indication of environmental characteristics associated with the positioning AI/ML model. The one or more processors may be configured to determine a target area to collect the positioning training data based on the request. The target area may be based on the environmental characteristics associated with the positioning AI/ML model and/or the availability of one or more that are capable of providing the positioning training data. The network nodes may include any combination of one or more Positioning Reference Units (PRUs) or one or more Radio Access Network (RAN) nodes. The one or more processors may be configured to determine a list of PRUs that can provide the positioning training data. The one or more processors may be configured to determine a positioning measurement type associated with the positioning training data. In some examples, the positioning measurement type may include an uplink (UL) or downlink (DL) Time of Arrival (ToA), an UL or DL Time Difference of Arrival (TDoA), and/or an Angle of Arrival (AoA). The one or more processors may be configured to send a collection request for the positioning training data. The collection request may include an indication of the target area, the list of the PRUs, and/or the positioning measurement type. The one or more processors may be configured to receive a positioning training data report. The positioning training data report may include the positioning training data.

The environmental characteristics may include an indication of whether the requested positioning training data is to be used for a Line-of-Sight (LoS) or a non-LoS scenario, an indication of whether the requested positioning AI/ML model is to be used for an indoor scenario or an outdoor scenario, and/or an indication of whether the requested positioning training data is to be used for an urban area or a suburban area. The one or more processors may be configured to determine the list of WTRUs based on a distribution of the WTRUs within the target area.

The request for positioning training data may include an indication of mobility characteristics associated with the positioning training data. The mobility characteristics may include an indication of whether the positioning training data is associated with stationary wireless transmit/receive units (WTRUs) or moving WTRUs. The list of the PRUs may be based on the indication of mobility characteristics associated with the positioning training data.

In some embodiments, the request for positioning training data may include the indication of the positioning method type associated with the positioning training data. In some embodiments, the request for positioning training data may include an indication of a time of day associated with the positioning training data and/or an indication of performance requirements. The performance requirements may include a positioning accuracy and/or a model interference latency. The collection request may include the indication of the time of day and/or the indication of the performance requirements.

In certain embodiments, the network device may include a network data analytics function (NWDAF), and wherein the collection request may be sent to a Location Management Function (LMF).

In some embodiments, the network device may include a Location Management Function (LMF), and the request may be received from a network data analytics function (NWDAF).

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of an Analytics logical function (AnLF) using ML model provisioning services from a Model Training logical function (MTLF).

FIG. 3 illustrates an example of training data collection for positioning model training.

FIG. 4 illustrates an example of an MTLF-initiated AIML positioning model training and data collection procedure.

FIG. 5 illustrates an example of an LMF-initiated target artificial intelligence/machine learning (AIML) positioning model training and data collection procedure.

### DETAILED DESCRIPTION

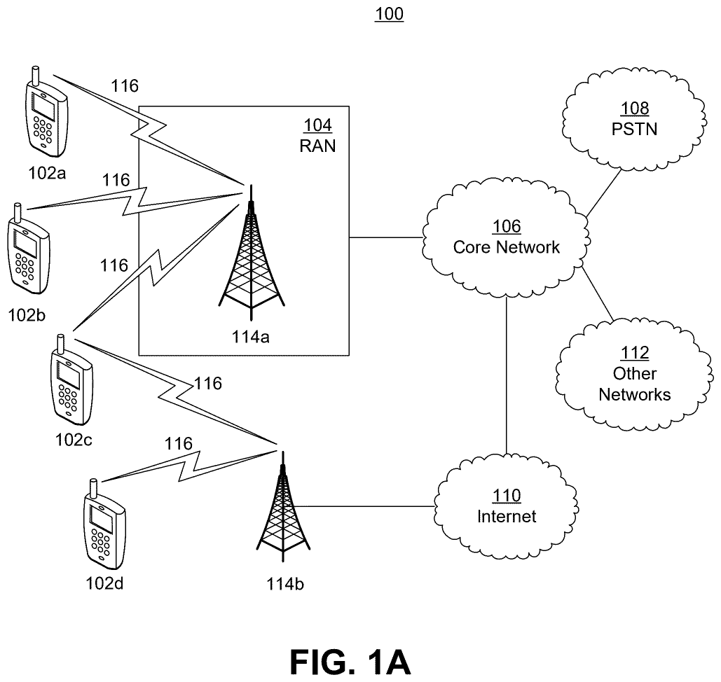

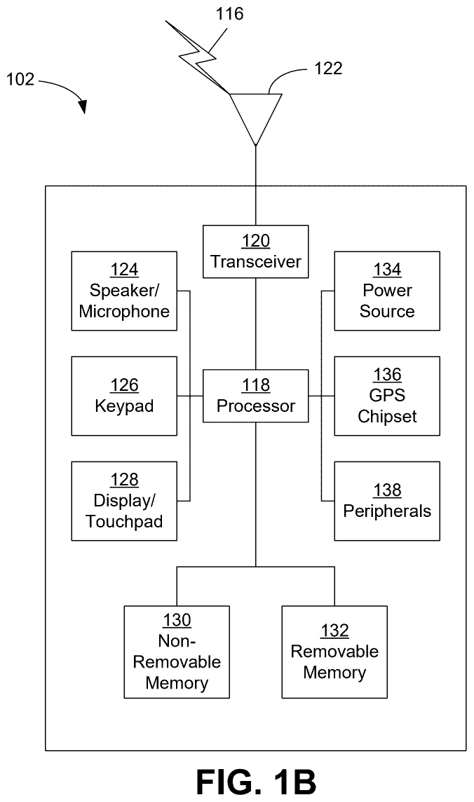

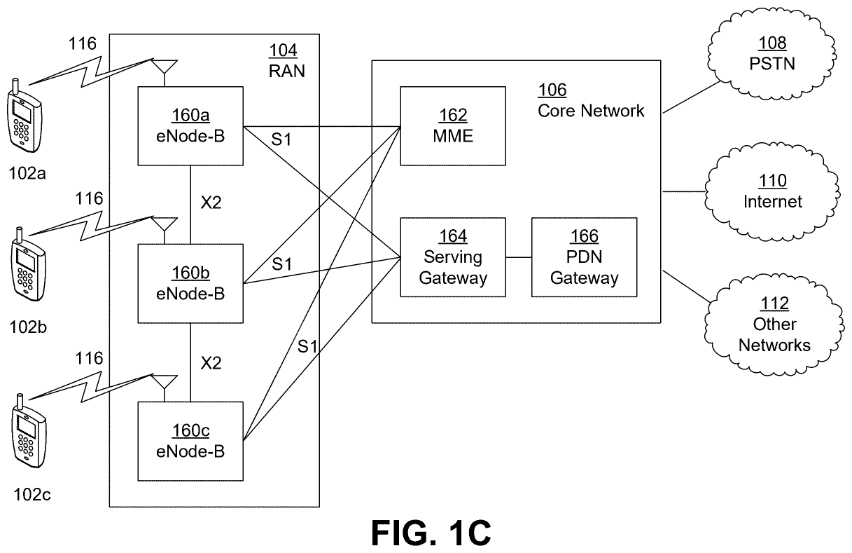

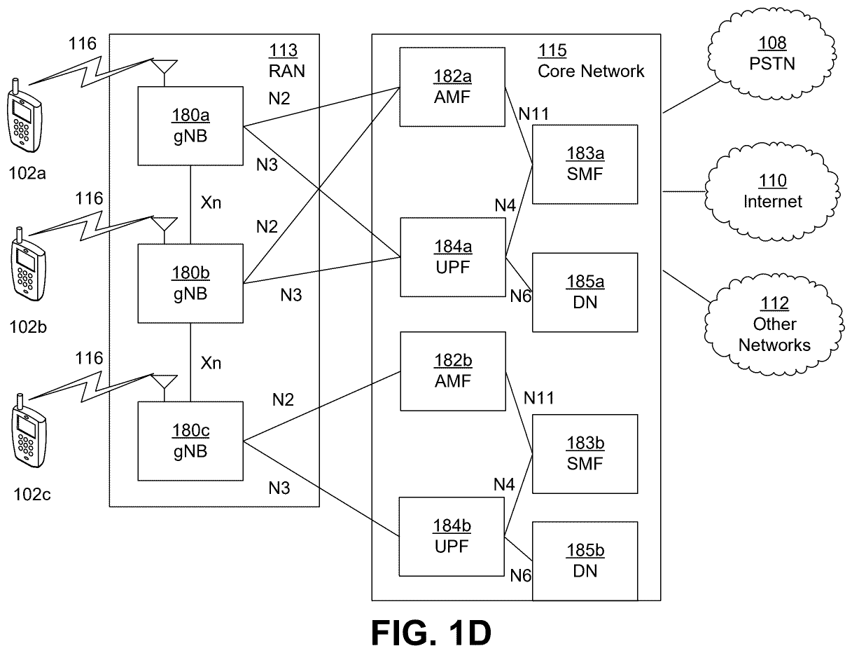

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc”mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment.

The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Artificial Intelligence / Machine Learning (AI/ML) may be integrated into cellular networks, such as 5G and future-generation wireless networks. A network data analytics function (NWDAF) may be provided in the 5G core network. The NWDAF can provide various analytics, for example, observed service experience analytics, to consumers such as other Network Functions in the 5GC. The NWDAF can support AI/ML model training and provisioning, model transfer, data collection, and/or model performance monitoring.

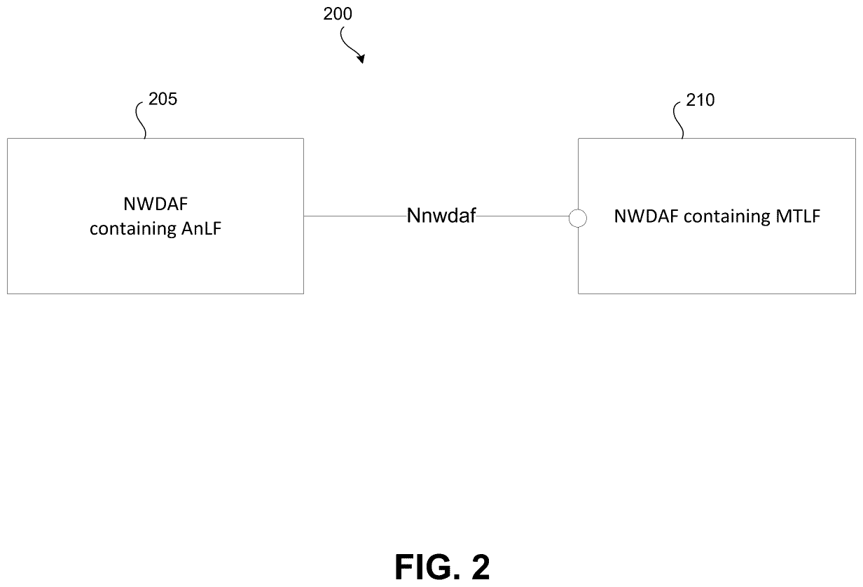

FIG. 2 illustrates an example 200 of an Analytics logical function (AnLF) 205 using ML model provisioning services from a MTLF 210. Analytics logical function (AnLF) 205 and model training logical function (MTLF) 210. The AnLF 205 may be responsible for inference, analytics information derivation, and/or analytics service exposure. The MTLF 210 may be responsible for AI/ML model training and exposing new training services, such as providing trained AI/ML models. The MTLF 210 may allow the Analytics Logical Function (AnLF) 205 to use trained ML model provisioning services, for example, as shown in FIG. 2.

Positioning methods may be geometry based and/or may not perform well in some conditions, for example, such as when Line-Of-Sight (LOS) measurement is not available. AI/ML-based algorithms may improve the positioning accuracy in those conditions. Direct AI/ML positioning and AI/ML-assisted positioning methods may be provided. With Direct AI/ML positioning, the AI/ML model may produce WTRU location as the output, while with AI/ML-assisted positioning, the AI/ML may produce enhanced measurements for WTRU positioning calculations.

A plurality of use cases may be identified based on, for example, where the AI/ML model resides and/or whether Direct AI/ML positioning or AI/ML-assisted positioning is used. A first example use case (Case 1) may be defined by WTRU-based positioning with a WTRU-side model, and with direct AI/ML or AI/ML assisted positioning provided. A second example use case (Case 2a) may be defined by WTRU-assisted/LMF-based positioning with a WTRU-side model, and with AI/ML assisted positioning. A third example use case (Case 2b) may be defined by WTRU-assisted/LMF-based positioning with a LMF-side model, and with direct AI/ML positioning. A fourth example use case (Case 3a) may be defined by NG-RAN node assisted positioning with a gNB-side model, and with AI/ML assisted positioning. A fifth example use case (Case 3b) may be defined by NG-RAN node assisted positioning with a LMF-side model, and with direct AI/ML positioning.

The examples described herein may focus on Case 2b and 3b, that is, the AI/ML mode is hosted at the network side (e.g., LMF or MTLF 210). The measurement inputs and/or training data may come from the WTRU (Case 2b) and/or gNB (Case 3b). However, the examples are not limited to just these use cases, and for example, may be applicable to any of the use cases described herein. The network elements described herein, such as the LMF, MTLF, AMF, etc. may be implemented on one or more servers that include a processor, memory, transceiver, and possibly other hardware and software, for instance, such as that hardware described for the WTRU in FIG. 1B (e.g., processor 118, the memory 130, 132, and/or the transceiver 120). For example, the processor may execute instructions stored in the memory to cause the network element to perform the various operations of the VFL server and/or the VFL client described herein.

The AIML model training in 5G Core network (5GC) may depend on simulations or real environment. The examples described herein may relate to real-environment training data collection where, for example, a network training function and/or server may collect training data (e.g., measurements, ground-truth label, etc.) from the WTRUs and/or Radio Access Network (RAN) nodes. A specific type of WTRU, a Positioning Reference Unit (PRU), whose location is known or trusted in the network, may be deployed to assist positioning model training. A PRU may measure downlink (DL) reference signal (e.g., Positioning Reference Signal (PRS)) and provide the measurements to the network for model training. The PRU may transmit uplink (UL) reference signal (e.g., Sounding Reference Signal (SRS)) that may be measured by the RAN node (e.g., a Next Generation Node B (gNB)). The RAN node may provide the measurements to the network for model training. WTRUs that are capable of providing required measurements or reference signal and accurate location information may also be used to assist model training (e.g., when PRUs are not available).

The model training function in 5GC may be implemented in various network functions. The examples described herein propose solutions where the model training may be performed in a MTLF and/or an LMF.

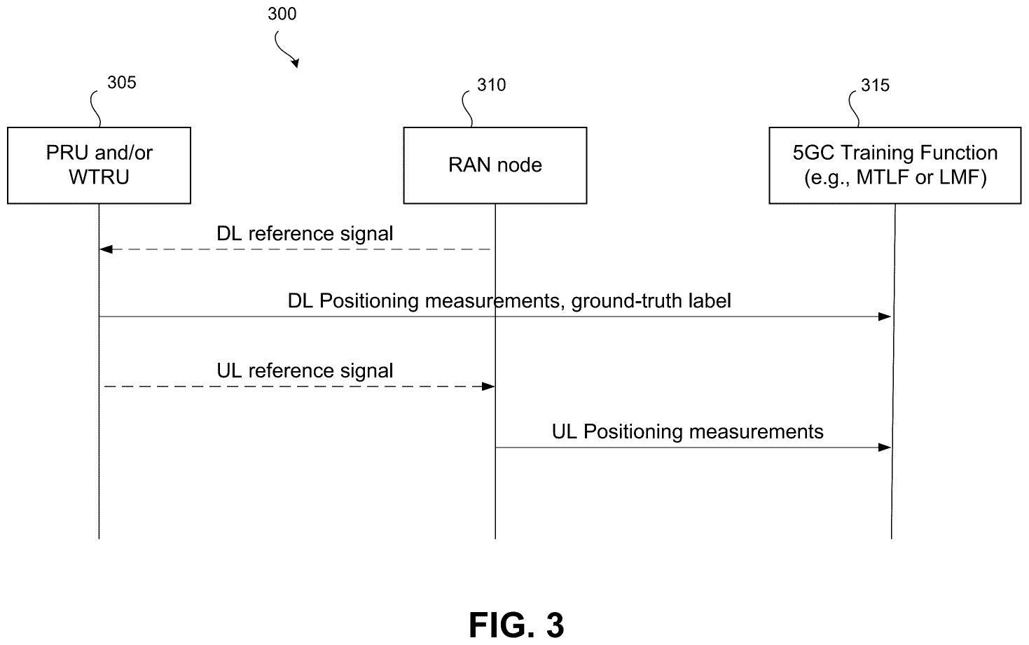

FIG. 3 illustrates an example procedure 300 for collecting training data from PRUs and/or WTRUs 305 and RAN nodes 310 for positioning model training in a 5GC 315. To enable the training data collection as shown in FIG. 3, a number of issues may be addressed. One issue is how the PRUs or WTRUs 305 are selected for providing training data. The selected PRUs and/or WTRUs 305 may be in a location or similar environment that the AIML model training is targeted for. A second issue is how to configure the PRUs and/or the WTRUs 305 or the RAN nodes 310 for performing measurements for model training. Depending on the various positioning methods to be used by the AIML model, the type of measurements and/or related reference signal configuration may be different. A third issue is how to collect the measurements from the PRUs and/or the WTRU 305 or the RAN nodes 310 for positioning model training in 5GC. The existing interface between the PRUs and/or the WTRU 305 or RAN nodes 310 and the 5GC training functions 315 may not support the collection of the training data. New interfaces may need to be established or the existing interface and/or procedures may need to be extended for this purpose.

The examples described herein may assume that the AIML positioning model training function resides in MTLF. However, the proposed examples may also apply to the cases where the model training function resides in other network functions.

A MTLF may be triggered by the network operator or model training administrator (e.g., from Operations, Administration and Maintenance (OAM)) or external positioning service provider or positioning model service consumer (e.g., Location Management Function (LMF)) to initiate model training for a specific target scenario. The purpose of the model training may be to create new AIML models or to update or improve existing models. The MTLF may initiate the model training based on the performance monitoring result of the existing models, for example, to improve underperforming models.

Several characteristics may be associated with the target artificial intelligence/machine learning (AIML) positioning model to be trained. The target AIML positioning model to be trained may be associated with environmental characteristics. Environmental characteristics may include any combination of (i) whether the target model is to be used for LOS or non-LOS scenario; (ii) whether the target model is to be used for indoor or outdoor scenario; and/or (iii) whether the target model is to be used for urban downtown or suburban area.

The target AIML positioning model to be trained may be associated with mobility characteristics. In some examples, the mobility characteristics may indicate the actual mobility state of the WTRU (e.g., whether the WTRU is moving, and if so, how fast the WTRU is moving). For example, the mobility characteristics may include whether the target model is to be used for stationary WTRUs, walking-speed WTRUs, driving-speed WTRUs, and/or high-speed WTRUs. For example, one target model may be intended to be used only for stationary WTRUs, whereas another target model may be used for both stationary WTRUs and walking-speed WTRUs.

The target AIML positioning model to be trained may be associated with is time of the day. The time of the day (e.g., morning, midnight, 8am-10am, etc.) indicates when the target model is to be used.

The target AIML positioning model to be trained may be associated with positioning methods or type of inputs. For example, the target AIML positioning model to be trained may be associated with one or more positioning methods, such as UL/DL Time of Arrival (ToA), UL/DL Time Difference of Arrival (TDoA), and/or Angle of Arrival (AoA).

The target AIML positioning model to be trained may be associated with performance requirements. Performance requirements may include positioning accuracy, model inference latency, etc.

The characteristics that are associated with the target AIML positioning model to be trained may be provided by the model training administrator or external service provider, or they may be derived from the description of one or more existing models. For example, the characteristics may be included as part of the meta-data of the target model.

Based on the characteristics and/or meta-data of the target model, the MTLF may derive a training data collection strategy that may include different types of information. One type of information that is part of the training data collection strategy may be whether there are one or multiple target areas from where the training data may be collected. The target area may be determined based a number of factors. One factor in determining the target area is the environmental characteristics of the selected target area may match that of the target model. For example, if the environmental characteristics of the target model indicates outdoor/urban-downtown area, the MTLF may select one or more target areas that are in urban-downtown districts. It is assumed that the MTLF is able to consult a geographic information database to help select the target areas. Another factor in determining target area is the availability of the one or more network nodes that are capable of providing AIML positioning model training data (e.g., measurements), and/or training data generation (e.g., generation of ground-truth label). The one or more network nodes may include any combination of PRUs and/or RAN nodes. In some examples, PRUs and/or transmit/receive point (TRPs) may only be available in some specific locations (e.g., due to cost). Selecting a target area where there are PRUs may improve the performance of the trained AIML model. However, in some embodiments, this may not be the mandatory criterion for selecting a target area. When matching environmental characteristics of the target model is more important, the MTLF may select a target area where the PRUs and/or TRPs are not available. In that case, the training data may be provided by selected WTRUs in the target area that support providing AIML training data.

Another factor in determining the target area may be the number of PRUs and/or WTRUs that are required to participate in providing training data. This number of PRUs and/or WTRUs may depend on the availability of the PRUs and/or WTRUs in the target area. More PRUs that provide training data may help achieve a better training result, but the number of PRUs is limited by the number of available PRUs in the area.

An additional factor in determining the target area may be a list of PRUs that will participate in providing training data. The MTLF may select a list of PRUs that can participate in providing the training data. For example, it may select a few PRUs that are more evenly distributed in the area. The MTLF may use a metric such as minimum separation distance (e.g., which may be the minimum allowed distance between the WTRUs) to help select the appropriate PRUs and/or WTRUs. It is assumed that the MTLF may have access (e.g., directly or through other network function) to the database of PRU deployment. The selection of PRUs and/or WTRUs may be left to other network functions such as AMF or LMF.

Another factor in determining the target area may be the type of measurement inputs that are required for model training. This mainly depends on the positioning methods of the target positioning model. For example, if the positioning measurement is based on UL-TDoA, the measurement of the UL-TDoA of the UL-SRS transmitted by the selected PRUs and/or WTRUs may be needed for the model training.

Yet another factor in determining the target area may be time and periodicity of the training period. The time and periodicity of the training period may indicate the time period that the training data can be collected and/or how the data collection can be repeated periodically.

After the MTLF has determined a training data collection strategy, the MTLF may locate the AMF or LMF that serves the target area. For example, the MTLF may consult network repository function (NRF) for the Access and Mobility Management/Function/Location Management Function (AMF/LMF) address that serves the target area. Then the MTLF may invoke AMF services (Example 1) or LMF services (Example 2) to initiate positioning data collection request. If Example 1 is used, the AMF may locate the LMF that serves the target area and forward the request to the LMF. For both Example 1 and Example 2, it is the LMF that executes the positioning data collection request.

In the positioning data collection request, the MTLF may specify a number of types of information according to the data collection strategy. The MTLF may specify the target area in the positioning data collection request, which may be in the form or 3GPP area identifiers such as Cell ID or geodetic coordinates. The target area may be used by the LMF to select/locate the PRUs and/or WTRUs that can provide the training data. The MTLF may specify, in the positioning data collection request, the number of PRUs and/or WTRUs that are required to participate in providing training data. The MTLF may specify, in the positioning data collection request, the list of selected PRUs and/or WTRUs. If this list is not provided in the request, the LMF may select the PRUs and/or WTRUs that can provide the training data based on the target area and the availability of the PRUs and/or WTRUs in the target area. The MTLF may specify, in the positioning data collection request, the positioning method and type of measurement (e.g. UL-Time Difference of Arrival (TDoA), UL-Angle of Arrival (AoA), etc). The MTLF may specify, in the positioning data collection request, the time and periodicity of the training period. The time and periodicity of the training period may indicate the time period that the training data may be collected and/or how the data collection can be repeated periodically.

The LMF that receives the training data collection request may perform one or a number of actions. For example, if the list of selected PRUs and/or WTRUs is not provided in the data collection request, the LMF may select the PRUs and/or WTRUs that can provide the training data based on the target area and the availability of the PRUs and/or WTRUs in the target area. If the number of PRUs and/or WTRUs is specified in the request, the LMF may select the PRUs and/or WTRUs accordingly.

The LMF may determine the source of the measurement inputs according to the positioning methods and the type of measurement. For example, if the UL-TDoA measurement is required, the measurement data may need to come from one or multiple gNB/TRPs. For example, if a DL-TDoA measurement is required, the measurement data may need to come from PRUs and/or WTRUs. The LMF may locate the source of the measurement input. For example, if the UL-TDoA is required, the LMF may locate multiple gNBs/TRPs that serve the selected PRU. The LMF may store a list of gNB/TRP identifiers or address for each PRU and/or WTRU that participates in providing training data. If different PRUs and/or WTRUs do not all support the same type of measurement (e.g., related to UL-TDoA method or UL-AoA method), then the LMF may only select the PRUs and/or WTRUs that support the target or desired type of measurement that is needed for the model training.

The LMF may send the positioning and/or measurement request to the located entities that are source of measurement inputs. The LMF may provide the selected PRU identifier and other information (e.g., as described in TS 38.305) in the positioning/measurement request. For example, if the located source of measurement inputs are gNB and/or TRPs, the LMF may send the positioning/measurement requests to the located gNBand /r TRPs. The LMF may send the positioning and/or measurement requests to the gNBs and/or TRPs according to the required time period and periodicity.

If the location of the selected PRU and/or WTRU is known at the LMF or other database in the network, the LMF may report the received measurement report together with the PRU and/or WTRU location to the MTLF (e.g., or via AMF to the MTLF). If the PRU and/or WTRU location is not known or obtained by the LMF, and the PRU and/or WTRU location is known at AMF, the AMF may append the PRU and/or WTRU location information to the received measurement report and send it to the MTLF.

If the location of the selected PRU and/or WTRU is not known in the LMF or other database in the network, the LMF may also initiate the request to the selected PRUs and/or WTRUs for reports of its current location and timestamp of the reported location. The LMF may associate the reported location with the received measurement report using the timestamp information, to make sure the time of PRU and/or WTRU reported location is the same or close to the time of received measurement report. And the LMF may forward the measurement report together with the PRU and/or WTRU location to the MTLF (e.g., or via AMF to the MTLF).

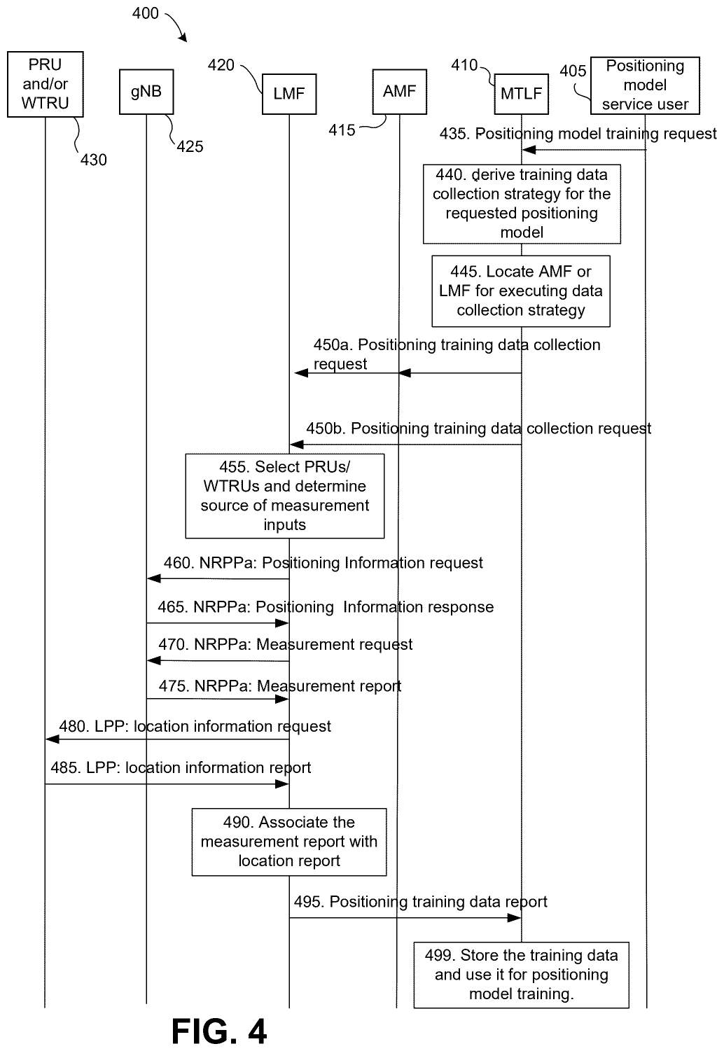

FIG. 4 illustrates an example MTLF-initiated AIML positioning model training and data collection procedure 400. At 435, the MTLF 410 or other network function in the 5GC may receive the request to perform positioning AIML model training. For example, the request may come from the network administrator, OAM, internal (e.g., another network function in 5GC) or external positioning model service user 405 (e.g., external positioning service provider/application server). The description or metadata of the target positioning model may be provided, such as environmental characteristics, mobility characteristics, positioning methods, and/or performance requirements (e.g., positioning accuracy, model inference latency, etc.). The MTLF 410 may also determine to initiate positioning training without request, e.g., to update an existing positioning model. The model training service consumer may invoke a Network Data Analytics Function (NWDAF) ML model training service (e.g., Nnwdaf_MLModelTraining service) to initiate the request and/or use the Model ID, Model File, and/or Model Information as the service input to represent the target positioning model information.

At 440, the MTLF 410 may derive an AIML model training strategy based on the metadata of the target model. It may determine the target area from where the training data is to be collected, the number of PRUs and/or WTRUs 430 to provide training data, the source of the positioning measurements, types of the positioning measurement, time and periodicity of the training period, etc. The MTLF 410 may directly select a list of PRUs and/or WTRUs 430 that may provide the training data. The MTLF 410 may interact with other network function or database (e.g., uniform data management (UDM)) for information that are needed, for example, such as the location and identifiers of the PRUs deployed in the target area, to derive the training strategy.

At 445, according to the determined target area, the MTLF 410 locates one or multiple AMF(s) 415 or LMF(s) 420 that serve the target area and support positioning model training procedure. The MTLF 410 may interact with another network functions (NFs) such as NRF to locate the addresses of capable AMF 415 or LMFs 420. For example, the NF profile of the LMFs 420 in the NRF may indicate whether they support model training data collection, and NRF may provide a list of LMFs 420 that are capable of this functionality upon the query of the MTLF 410.

At 450a, the MTLF 410 may send a positioning model training request and/or a positioning model training data collection request towards the located AMF 415. The request may contain the content of the model training strategy and a list of selected PRUs. The AMF 415 may further locate (e.g., through interaction with the NRF) the LMFs 420 based on the target area, supported positioning methods, types of measurements, etc. The AMF 415 may then forward the model training request to the LMF(s) 420. At 450b, the MTLF 410 may directly send the positioning model training request and/or the positioning model training data collection request towards the located LMF(s) 420.

At 455, if the list of selected PRUs and/or WTRUs 430 is not included in the request, the LMF 420 may select a list of PRUs and/or WTRUs 430 that can provide the training data in the target area. The LMF 420 may interact with other network function(s) or database(s) to locate the capable PRUs and/or WTRUs 430. For example, the LMF 420 may query UDM for the list of PRUs deployed in the target area and their precise locations. Alternatively or additionally, the LMF 420 may query AMF 415 for the list of WTRUs in the target area that are capable of providing positioning training data and their locations. The LMF 420 may determine the source of the positioning measurement based on the content of the model training data collection request (e.g., positioning methods or expected types of measurements). For example, the LMF 420 may locate one or multiple gNBs 425 and/or TRPs that serve the selected PRUs and/or WTRUs 430 for receiving UL-TDoA related measurements.

At 460, the LMF 420 may send the NR Positioning Protocol A (NRPPa) message Positioning Information Request to the selected gNBs 425 and/or TRPs. In some examples, the message may be sent through the AMF 415. The LMF 420 specifies the selected PRU and/or WTRU 430 identifier in the request and provide other measurement related information, such as Sounding Reference Signal (SRS) transmission characteristics, time window of SRS transmission, etc. The time that the LMF 420 may choose to initiate this request may be based on the time information provided in the training data collection request.

At 465, the gNB 425 and/or TRP may respond with NRPPa message Positioning Information Request and return the positioning measurement related information, such as measurement configuration information (e.g. SRS configuration).

At 470 and 475, the LMF may send the NRPPa message Measurement Request to the gNB 425 and/or TRP to perform the positioning measurement and report the measurement result, and the gNB 425 or TRP may send the NRPPa message Measurement Report to the LMF 420. Note that, in some examples, 470 and 475 may repeat multiple times or periodically during the training time period.

At 480 and 485, if the location of the PRU 430 or WTRU 430 is not known at the LMF 420 or other network database, the LMF 420 may initiate the LPP procedure to obtain the precise location information of the PRU and/or WTRU 430.

At 490, if the WTRU is moving, the LMF 420 may need to associate the measurement report with the location information, so they occurred close enough in time domain, based on the timestamp information that's associated with received measurement report (475) and the timestamp information that's associated with the location information (485). The LMF 420 may keep such measurement result and associated location information.

At 495, based on received measurement configuration (465), measurement report (475) and/or location information (e.g., either already known at LMF 420 or obtained via 485), the LMF 420 may form the positioning model training data and send it to the MTLF 410 (e.g., or through the AMF 415 to the MTLF 410). The LMF 420 may send the training data multiple times (e.g. periodically) during the training time period.

At 499, the MTLF 410 may store the training data and use it as the input for training positioning AI/ML models. The MTLF 410 may store the training data to the Analytics Data Repository Function (e.g., ADRF), using for example, Nadrf_DataManagement_StorageRequest service operation. The data collected for AI positioning model training may be used to train other/future ML training sessions of similar ML models or even different models.

The PRUs and/or WTRUs 430 or gNBs 425/TRP may receive requests related to AI positioning training data collection for more than one training data collection session, for example, for collecting data to train different ML models (e.g., one ML model with 5 hidden layers and another ML model with 3 hidden layers). The measurement or training data to be provided by the PRUs and/or WTRUs 430 or gNB 425/TRPs may be used for both training data collection tasks. In this case, the LMF may configure the training data collection process to avoid collecting the same measurement multiple times (e.g., for each training session). The LMF 420 may configure the PRUs and/or WTRUs 430 or gNBs 425 in an optimized manner. For example, if one data training session has training data to be provided every T, and a second training data session has training data to be provided every 2T, using the same configuration parameters, then the LMF 420 may only configure PRUs and/or WTRUs to report data every T, and then the LMF may process the data to produce training dataset for the two sessions (e.g., one with T spaced samples and one with 2T spaced samples).

Some examples relate to LMF initiated data collection for positioning model training. For instance, if the LMF is capable of performing AIML positioning model training, the LMF may be triggered to initiate AIML model training. For example, if there is a location service request initiated from the location service client, and the LMF determines to apply AIML-based positioning method, and the model is not yet available or needs to be updated, the LMF may initiate the model training and data collection procedure.

When the MTLF is requested to train the AIML positioning model, as shown in 435 of FIG. 4, the MTLF may determine that the training may be delegated to a capable LMF. The MTLF may query the NRF for training-capable LMF and then request the LMF (e.g., either directly or through the AMF) to perform the AIML positioning model training. The MTLF may determine the training data collection strategy and pass the training data collection strategy on to the LMF or the MTLF may leave it to the LMF itself to make the training data collection strategy.

The LMF may apply the procedures 455 to 490 of FIG. 4 to collect training data and perform model training.

After the AIML positioning model is available, the LMF may transfer the model to the NWDAF repository so the model can be used by the NWDAF too or shared with other network functions.

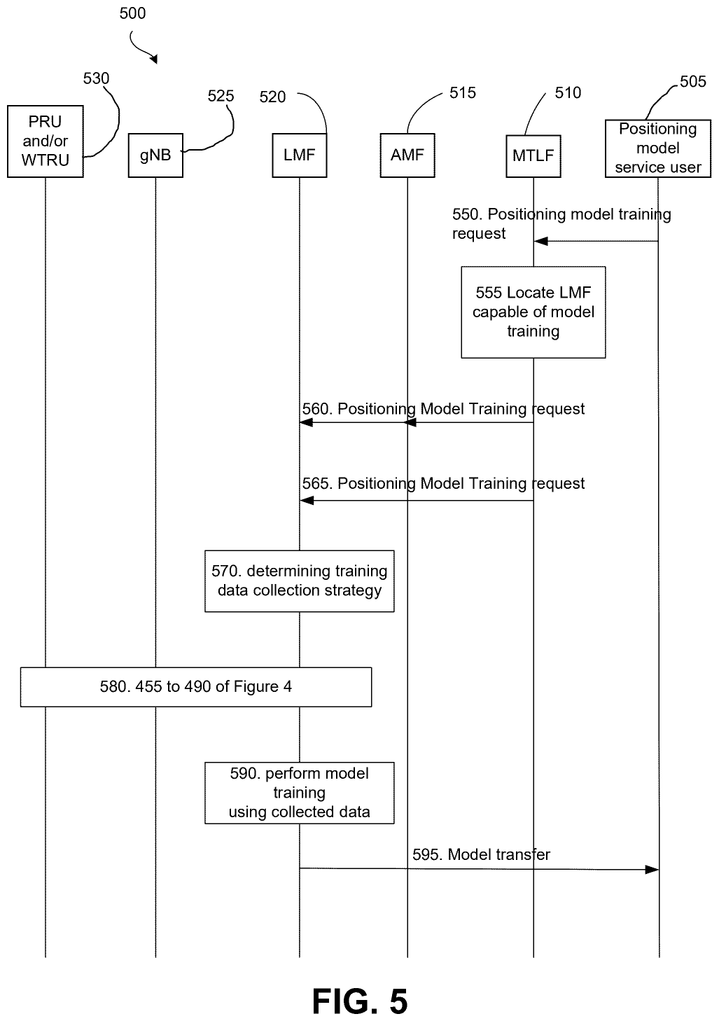

FIG. 5 illustrates example procedure 500 for LMF-initiated AIML positioning model training and data collection. At 550, the MTLF 510 or other network function in the 5GC may receive the request to perform positioning AIML model training. For example, the request may come from the network administrator, OAM, internal (e.g., another network function in 5GC) or external positioning model service 505 user (e.g. external positioning service provider and/or application server). The description or metadata of the target positioning model may be provided, such as environmental characteristics, mobility characteristics, positioning methods, and/or performance requirements (e.g., positioning accuracy, model inference latency, etc.).

The MTLF 510 may also determine to initiate positioning training without request, e.g., to update an existing positioning model. The model training service consumer may invoke a NWDAF ML model training service (e.g., Nnwdaf_MLModelTraining service) to initiate the request and use the Model ID or Model File or Model Information as the service input to represent the target positioning model information.

At 555, the MTLF 510 may determine the target area that the requested AIML model and query the NRF for the LMFs 520 serving the area and capable of AIML positioning model training. The MTLF 510 may select the LMF 520 to perform the AIML positioning model training.

At 560 and 565, the MTLF 510 initiates the model training request towards the selected LMF 520 via the AMF 515. The request may contain the Model ID or Model information that can be derived from the model training request. The MTLF 510 may provide an address or URL of the model repository for the LMF 520 to transfer the trained model. In some examples, the MTLF 510 initiates the model training request directly towards the selected LMF 520. At 570, the LMF 520 derives the training data collection strategy. The strategy may be analogous to that described in 440 of FIG. 4. At 580, the LMF 520 performs 455 to 490 of FIG. 4 to collect training data. At 590, the LMF 520 performs positioning model training using the collected data. At 595, the LMF 520 may transfer the trained positioning model to the NWDAF repository, for example, using the address or URL of the model repository received at 560 and 565.

1. A network device comprising:
one or more processors configured to:
receive a request for a positioning artificial intelligence or machine learning (AI/ML) model, wherein the request comprises an indication of environmental characteristics associated with the positioning AI/ML model;
determine a target area to collect positioning training data based on the request for the positioning AI/ML model, wherein the target area is based on (i) the environmental characteristics associated with the positioning AI/ML model or (ii) availability of one or more network nodes that are capable of providing the positioning training data;
determine a list of network nodes that are capable of providing the positioning training data;
determine a positioning measurement type associated with the positioning AI/ML model;
send a collection request for the positioning training data, wherein the collection request comprises an indication of the target area, the list of the network nodes, and the positioning measurement type; and
receive a positioning training data report, wherein the positioning training data report comprises the positioning training data.

2. The network device of claim 1, wherein the one or more network nodes comprises any combination of one or more Positioning Reference Units (PRUs) or one or more Radio Access Network (RAN) nodes.

3. The network device of claim 1, wherein the positioning measurement type comprises an uplink (UL) or downlink (DL) Time of Arrival (ToA), an UL or DL Time Difference of Arrival (TDoA), or an Angle of Arrival (AoA).

4. The network device of claim 1, wherein the environmental characteristics comprise an indication of whether the requested positioning AI/ML model is to be used for a Line-of-Sight (LoS) or a non-LoS scenario, an indication of whether the requested positioning AI/ML model is to be used for an indoor scenario or an outdoor scenario, or an indication of whether the requested positioning AI/ML model is to be used for an urban area or a suburban area.

5. The network device of claim 1, wherein the one or more processors are configured to determine the list of WTRUs based on a distribution of the WTRUs within the target area.

6. The network device of claim 1, wherein the request for positioning AI/ML model comprises:
an indication of mobility characteristics associated with the positioning training data, wherein the mobility characteristics comprise an indication of whether the positioning AI/ML model is associated with stationary wireless transmit/receive units (WTRUs) or moving WTRUs;
wherein the list of the network nodes is based on the indication of mobility characteristics associated with the positioning AI/ML model.

7. The network device of claim 1, wherein the request for positioning training data comprises the indication of the positioning method type associated with the positioning training data.

8. The network device of claim 1, wherein the request for positioning training data comprises:
an indication of a time of day associated with the positioning training data; or
an indication of performance requirements, wherein the performance requirements comprise a positioning accuracy or a model interference latency; and
wherein the collection request comprises the indication of the time of day or the indication of the performance requirements.

9. The network device of claim 1, wherein the network device comprises a network data analytics function (NWDAF), and wherein the collection request is sent to a Location Management Function (LMF).

10. The network device of claim 1, wherein the network device comprises a Location Management Function (LMF), and wherein the request for positioning AI/ML model is received from a network data analytics function (NWDAF); or
wherein the network device comprises a Model Training logical function (MTLF), and wherein the request for positioning AI/ML model is received from a LMF.

11. A method comprising:
receiving a request for a positioning artificial intelligence or machine learning (AI/ML) model, wherein the request comprises an indication of environmental characteristics associated with the positioning AI/ML model;
determining a target area to collect positioning training data based on the request for the positioning AI/ML model, wherein the target area is based on (i) the environmental characteristics associated with the positioning AI/ML model or (ii) availability of one or more network nodes that are capable of providing the positioning training data;
determining a list of network nodes that are capable of providing the positioning training data;
determining a positioning measurement type associated with the positioning AI/ML model;
sending a collection request for the positioning training data, wherein the collection request comprises an indication of the target area, the list of the network nodes, and the positioning measurement type; and
receiving a positioning training data report, wherein the positioning training data report comprises the positioning training data.

12. The method of claim 11, wherein the one or more network nodes comprise any combination of one or more Positioning Reference Units (PRUs) or one or more Radio Access Network (RAN) nodes.

13. The method of claim 11, wherein the positioning measurement type comprises an uplink (UL) or downlink (DL) Time of Arrival (ToA), an UL or DL Time Difference of Arrival (TDoA), or an Angle of Arrival (AoA).

14. The method of claim 11, wherein the environmental characteristics comprise an indication of whether the requested positioning AI/ML model is to be used for a Line-of-Sight (LoS) or a non-LoS scenario, an indication of whether the requested positioning AI/ML model is to be used for an indoor scenario or an outdoor scenario, or an indication of whether the requested positioning AI/ML model is to be used for an urban area or a suburban area.

15. The method of claim 11, wherein the list of WTRUs is determined based on a distribution of the WTRUs within the target area.

16. The method of claim 11, wherein the request for positioning AI/ML model comprises:
an indication of mobility characteristics associated with the positioning training data, wherein the mobility characteristics comprise an indication of whether the positioning AI/ML model is associated with stationary wireless transmit/receive units (WTRUs) or moving WTRUs; and
wherein the list of the network nodes is based on the indication of mobility characteristics associated with the positioning AI/ML model.

17. The method of claim 11, wherein the request for positioning training data comprises the indication of the positioning method type associated with the positioning training data.

18. The method of claim 11, wherein the request for positioning training data comprises:
an indication of a time of day associated with the positioning training data; or
an indication of performance requirements, wherein the performance requirements comprise a positioning accuracy or a model interference latency; and
wherein the collection request comprises the indication of the time of day or the indication of the performance requirements.

19. The method of claim 11, wherein the method is performed by a network data analytics function (NWDAF), and wherein the collection request is sent to a Location Management Function (LMF).

20. The method of claim 11, wherein the method is performed by a Location Management Function (LMF), and wherein the request for positioning AI/ML model is received from a network data analytics function (NWDAF); or
wherein the network device comprises a Model Training logical function (MTLF), and wherein the request for positioning AI/ML model is received from a LMF.
